(19) United States
(12) Patent Application Publication
(10) Pub. No.: US 2008/0114680 A1
(43) Pub. Date: May 15, 2008

(54) METHOD AN SYSTEM FOR PRINTING AN IMAGE FROM AN ARBITRARY WEBSITE

(75) Inventors: Michael J Toutonghi, Bellevue, WA (US); Bradley Schick, Seattle, WA (US); Tosh Meston, Woodinville, WA (US)

Correspondence Address: HAHN AND MOODLEY, LLP, P.O. BOX 52050, MINNEAPOLIS, MN, 55402, US

(73) Assignee: Vizrea Corporation, Seattle, WA (US)

(21) Appl. No.: 11/559,391

(22) Filed: Nov. 13, 2006

(51) Int. Cl. H04L 9/32; G06Q 30/00

(52) U.S. Cl. 705/50; 705/26; 705/1

(57) ABSTRACT

One embodiment of the invention provides a method to for printing an image from an arbitrary website. The method comprises, on a server system associated with the arbitrary website generating a link to the image; and sending the link to a client system; and on a server system associated with an online print service receiving the link to the image in the form of a request from the client system; retrieving the image from the server system associated with the arbitrary website; making a physical print of the image; and mailing the physical print to a mailing address.

### FIELD

Embodiments of the invention relate to a method and system for printing an image from an arbitrary website

### BACKGROUND

An online print service is one that allows a user to upload images to a server system associated with the online print service, thereby to create a web or online photo album. The online print service may allow a user to invite others to view images in the web photo album. Further, it is possible to order a physical or hardcopy of an image in the web photo album from the online print service, for a fee.

An arbitrary website refers to any website that provides content. An example of an arbitrary website includes weblogs (blogs), or business websites.

### SUMMARY

In one embodiment the invention provides a method to print an image from an arbitrary website. The method comprises on a server system associated with arbitrary website, generating a link to the image; and sending the link to a client system. Further, the method includes, on a server system associated with an online print service, receiving the link to the image in the form of a request from the client system, retrieving the image from the server system associated with the arbitrary website, making a physical print of the image, and mailing the physical print to a mailing address.

### BRIEF DESCRIPTION OF THE DRAWINGS

FIG. 1 shows the architecture of a network which includes a server system associated with an arbitrary website, and a server system associated with an online print service, in accordance with one embodiment of the invention;

FIG. 2 shows a representation of a client system, in accordance with one embodiment of the invention;

FIG. 3 shows a representation of the server system associated with the arbitrary website, in accordance with one embodiment of the invention;

FIG. 4 shows the component of a server system associated with the online print service, in accordance with one embodiment of the invention;

FIG. 5 shows a setup interaction between the server system associated with an arbitrary website, and a server system associated with an online print service in accordance with one embodiment of the invention;

FIG. 6 shows the operations performed by a server system of an arbitrary website to create and send a print link to a client system, in accordance with one embodiment of the invention;

FIG. 7 shows a flowchart of operations performed by a client system in order to print an image from a server system, in accordance with one embodiment of the invention;

FIG. 8 shows a flowchart of operations performed by a server system in order to process a print request received a client, in accordance with one embodiment of the invention; and

FIG. 9 shows a high level block diagram of hardware that may be used to implement a client system, a server system associated with an arbitrary website, or a server system associated an online print service, in accordance with one embodiment of the invention.

### DETAILED DESCRIPTION

Embodiments of the invention describe a technique whereby a user of a client system may order a physical or hardcopy of an image from an arbitrary website while browsing the content of the arbitrary website, without having to first download the image. The order for the physical copy of the image may be processed by a server system associated with an online print service, such as Shutterfly or Snapfish, which retrieves the image from a server system associated with the arbitrary website.

In one embodiment, a business relationship is established between the respective operators of the online print service and the arbitrary website in terms of which a monetary amount in respect of the image is collected on behalf of the arbitrary website operator by the online print service operator and paid over to the arbitrary website operator.

Advantageously, the techniques described herein do not require the image data for the image to be printed to be stored on the server system associated the online print service, thus reducing the data storage capacity required to operate an online print service. Moreover, allowing the data for the image to be printed to be stored on the server system associated with the arbitrary website has certain benefits. For example, consider the case where the arbitrary website operator is a professional photographer. In this case, by allowing the professional photographer to store his/her image data on a server system that is independent of a server system associated with an online print service, the professional photographer may achieve more control over his/her image data by having more freedom with respect to, for example, a resolution of the images.

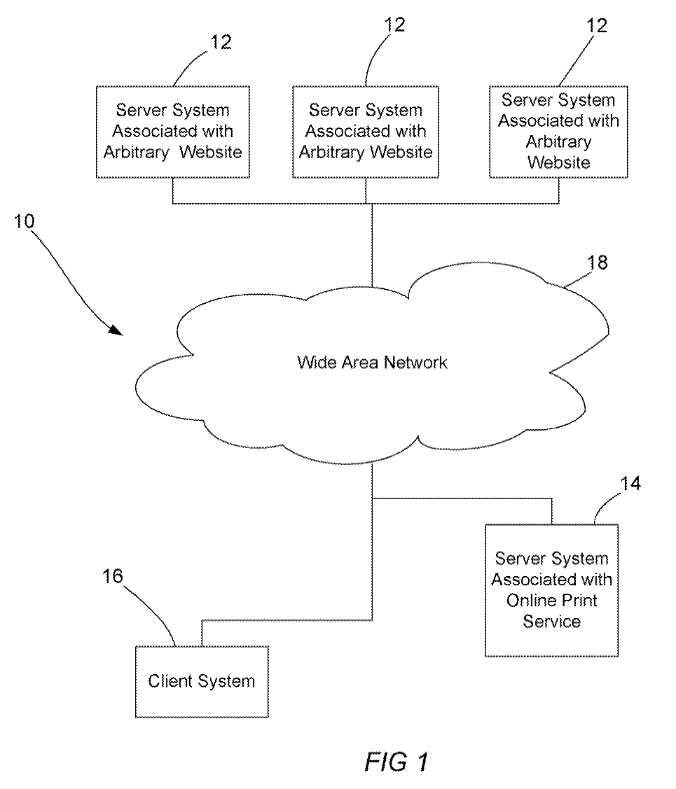

Turning now to the drawings, FIG. 1 shows the architecture of a network (10) which includes a server system (12) associated with an arbitrary website, and a server system (14) associated with an online print service. The server systems (12) and (14) cooperate to enable a client system (16) to order a physical copy of an image stored or hosted on the server system (12), as will be described in greater detail below. In FIG. 1, only three server systems (12) have been shown, however it is to be understood that there is no limit to the number of server systems (12) that may cooperate with the server system (14) associated with the online print service in order to perform the printing technique of the present invention. The server systems (12), and (14), and the client system (16) communicate via a Wide Area Network (18) which, in one embodiment, may be the Internet. In one embodiment, communications between the components (12), (14), (16) may be in accordance with the Hypertext Transfer Protocol (HTTP), or the Secure Hypertext Transfer Protocol (sHTTP) over the Transmission Control Protocol/Internet Protocol (TCP/IP).

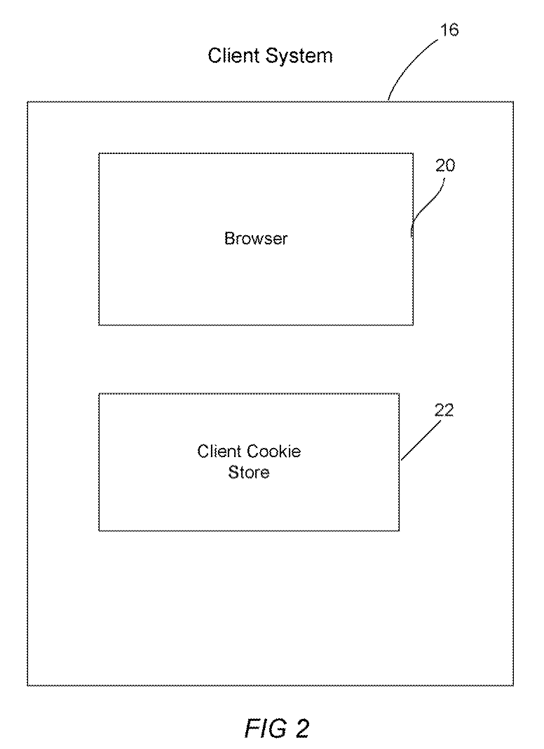

FIG. 2 shows a representation of the client system (16), in accordance with one embodiment of the invention. In this representation, the client system (16) includes a browser (20), and a client cookie store (22). The client system (16) may represent any client computing device including a desktop personal computer (PC), a notebook or laptop PC, a handheld device such a Personal Digital Assistant (PDA), a mobile telephone, or a Pocket PC.

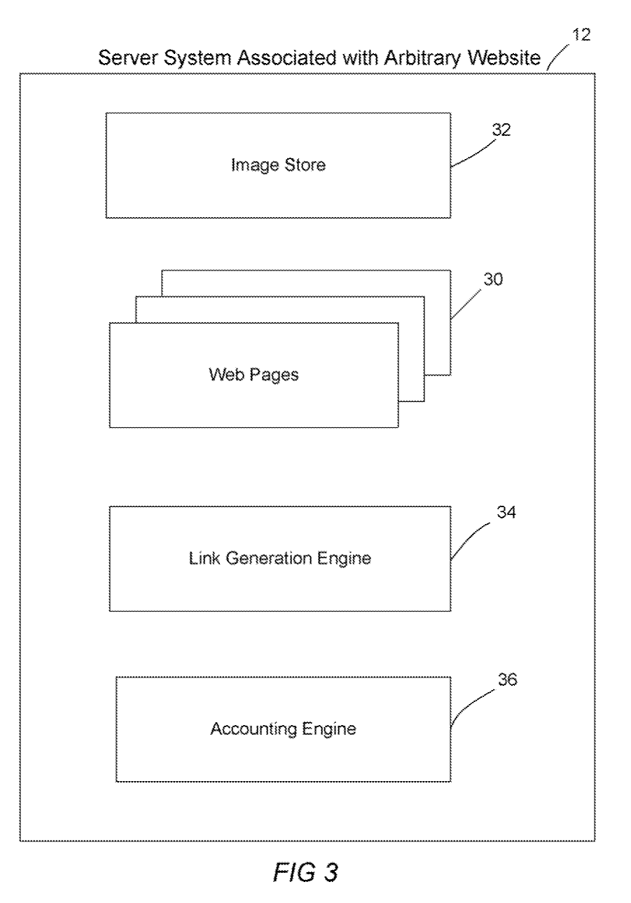

FIG. 3 of the drawing shows a representation of a server system (12) associated with the arbitrary website, in accordance with one embodiment of the invention. In this representation, the server system (12) includes content in the form of one or more web pages (30), an image store (32) to store printable images associated with a counter, a link generation engine (34), and an accounting engine (36) to accumulate account data relating to revenue generated through providing the images to the users.

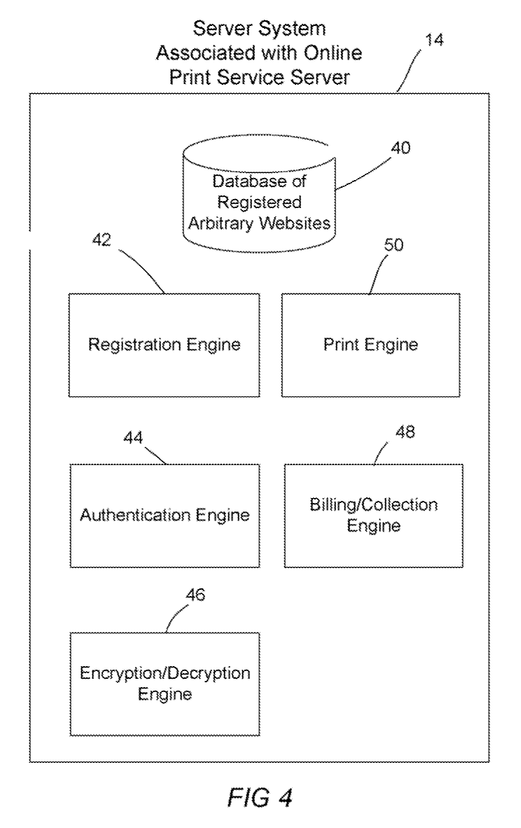

Referring now to FIG. 4 of the drawings, the components of the server system (14) associated with the online print service, in accordance with one embodiment of the invention, is shown. As will be seen, the server system (14) includes a database of registered arbitrary websites (40), a registration engine (42), an authentication engine (44), an encryption/decryption engine (46), a billing/collection engine (48), and a print engine (50).

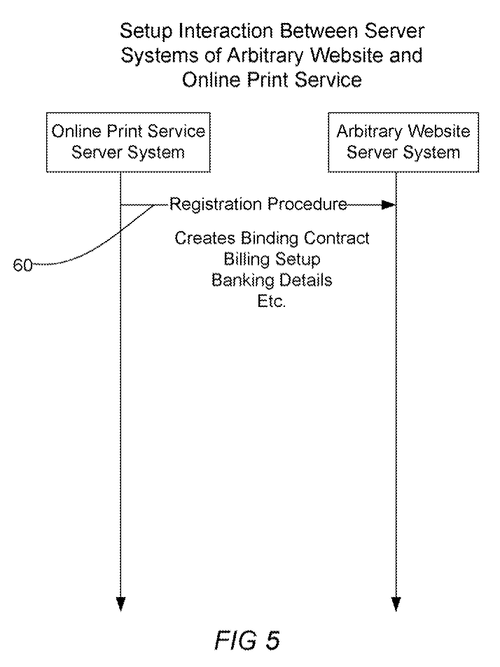

FIG. 5 shows a setup interaction between the server system (12) associated with the arbitrary website, and the server system (14) associated with the online print service, in accordance with one embodiment of the invention. Referring to FIG. 5, the setup interaction includes performance of a registration procedure (60) between the server systems (12), and (14). At the end of the registration procedure (60), a binding contract is created between the operators of the server systems (12), and (14). In one embodiment, the registration procedure may include capturing at the server system (14), billing preferences, banking details, and other accounting type information relating to the operator of the server system (12). For example the operator of the server system (12) may stipulate that a flat fee is to be collected in respect of any image to be printed from the server system (12). In this case, part of the registration procedure (60) will include implementing a rule within billing/collection engine (48) of the server system (14) in order to ensure that the stipulated fee is collected from a user of the client system (16) on behalf of the operator of the server system (12).

In one embodiment the binding contract between the operators of the server systems (12) and (14) created as part of the registration procedure (60) may stipulate that the images retrieved from the server system (12) are to be provided at no cost to a user of the client system (16). For this embodiment, the binding contract may stipulate further that the costs associated with printing and mailing the image to a user of the client system (16) are to be passed to the operator of the server system (12). The foregoing is intended to be merely representative of the types of billing arrangements that may be entered into between the operators of the server systems (12), and (14), in accordance with the registration procedure (60). As such, the foregoing is intended to non-limiting.

Part of the registration procedure (60) may include sending an encryption key generated by the encryption/decryption engine (46) to the server system (12). The benefit of sending the encryption key will be apparent from the description below.

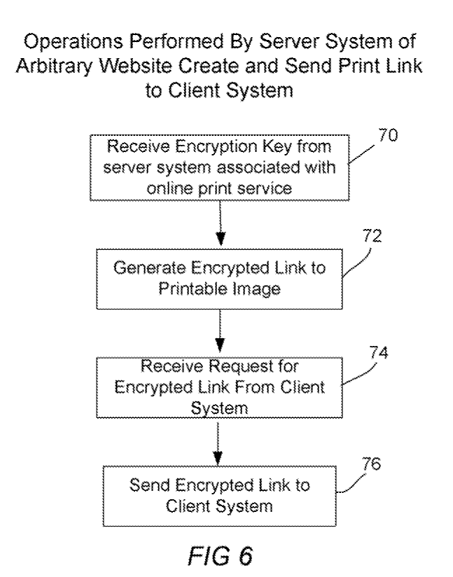

FIG. 6 of the drawings shows a flowchart of operations performed by a server system (12) of an arbitrary website to create and send a link (print link) to a client system (16), in accordance to one embodiment of the invention.

Referring now to FIG. 6, at block 70 the server system (12) receives the encryption key from the server system (14). It is to be understood that the operation at block 70 is optional, and is not always required. At block 72, the server system (12) generates a link to the image that is to be printed using the link generation engine (34). If encryption is required, then the operation at block 72 includes generating an encrypted link to the image to be printed. At block 74 the server system (12) receives a request for the link generated at block 72 from the client system (16). At block 76, the server system (12) sends the link to the client system (12).

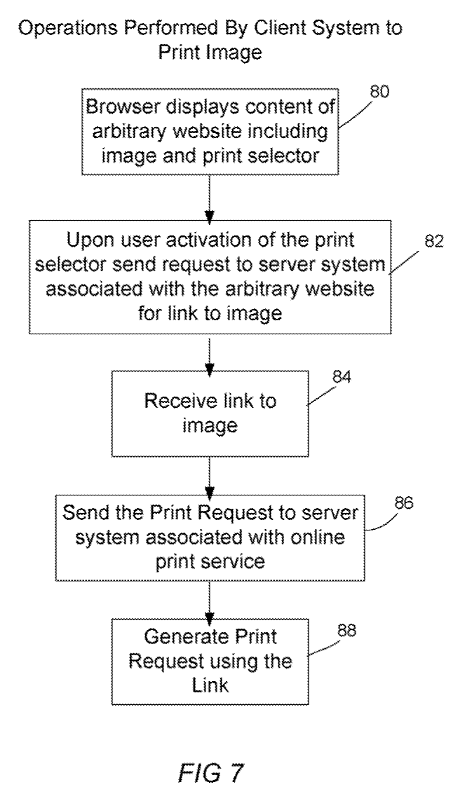

Referring to FIG. 7 of the drawings, there is shown a flowchart of operations performed by the client system (16) in order to print an image from the server system (12), in accordance with one embodiment of the invention. As will be seen, at block 80, the browser (20) of the client system (16) displays content of the arbitrary website associated with the server system (12). The content includes an image and a print selector. For example, in one embodiment, the print selector may be an icon or button which a user of the client system (16) can activate in order to send a request to the server system (12) for a link to the image.

At block 82, the user of the client system (16) activates the print selector which causes a request to be sent from the client system (16), to the server system (12), the request being for the link to the image.

At block 84, the client (16) receives the link to the image from the server. At block 86, the client system (16) generates a request (print request) using the link received from the server system (12). The request is sent to the server system 14, at block 88.

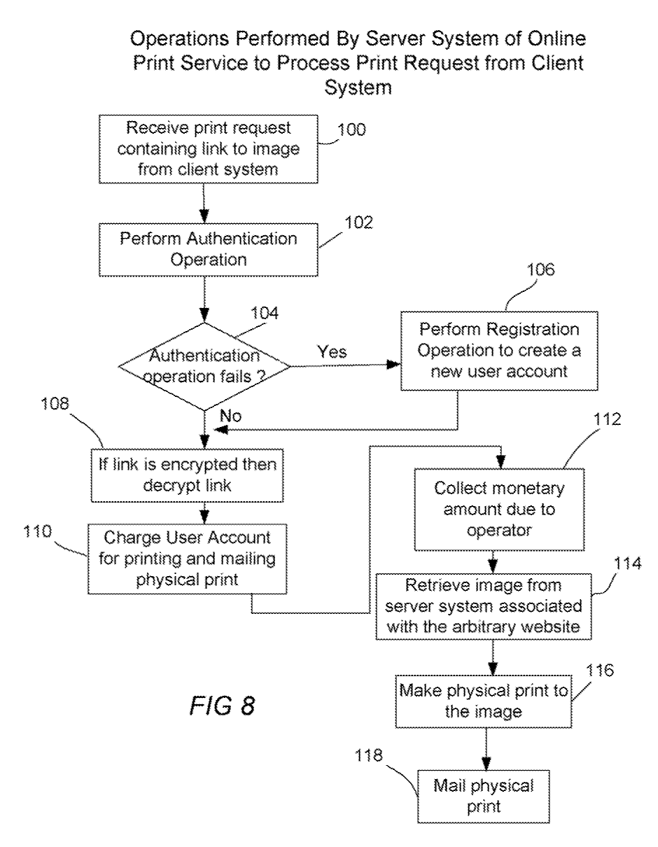

FIG. 8 shows operations performed by the server system (14) in order to process the print request received from the client system (16), in accordance with one embodiment. Referring to FIG. 8 at block 100, the server system (14) receives the print request containing the link to the image that is to be printed from the client system (16). At block 102 the authentication engine (44) performs an authentication operation to authenticate the client system (16). In one embodiment, where the link contained in the print request is an encrypted link encrypted in accordance with the encryption key supplied by the server system (14) to the server system (12), the requesting client system (16) is automatically authenticated. The assumption here is that for the requesting client system (16) to have obtained the link encrypted with the encryption key supplied by the server system (14) to the server system (12), the requesting client must have property obtained the link from the server (12).

In another embodiment, the authentication operation performed at block 102 may require the client system (16) to pass an authentication challenge, for example, by supplying username and password information in order to login to the server system (14). In this authentication model, it assumed that the client system (16) has already created a user account with the online print server. In one embodiment, such a user account would include the identity of the user of the client system (16) as well as details relating to a payment mechanism. For example, one or more credit cards associated with the user of the client system (16) may be included as part of the user account in order to enable the print server (14) to bill the user for printing the image in the case of those embodiments in which the cost of printing is passed to the user.

At block 104, if the authentication fails then control is passed to block 106 where the registration engine (42) performs a registration operation to create a new user account. As alluded to above, the creation of the new user account captures personal information of the user such as the user's name, mailing address to which the physical image is to be sent, and financial data to enable payment for the physical image. In one embodiment in order to facilitate a response to the authentication challenge referred to above, the client system (12) retrieves a cookie from the client cookie store (22) and transmits the cookie to the server system (14). In this embodiment, the content cookie includes sufficient authentication data to authenticate the client system (12) to the server system (14).

If at block 104 the authentication operation succeeds then control is passed to block 110. At block 110 the link to the image is decrypted, provided that it was encrypted in the first instance. The operations performed at block 110 are performed by the encryption/decryption engine (46). It will be appreciated that block 110 is optional and may be actually performed as a part of the authentication operation of block 102. At block 112, the user account is charged for the printing and mailing of the physical print of the image. The operation at block 112 is only applicable or performed in the case where the binding contract between the operators of the server systems (12) and (14) created during registration procedures (60) (see FIG. 5) specify that the cost of printing and mailing the physical print image is to be charged to the user account. At block 114, the server system (14) collects a monetary amount due to the operator of the server system (12). The operation at block 114 is optional, again depending on the nature of the billing model that is set pursuant the binding contract created during the registration procedure (60) of FIG. 5. In one embodiment the monetary amount may be a fixed amount that may be specified in the binding contract created during the registration procedure (60). In another embodiment, the monetary amount may be a variable amount which is encoded in the encrypted link itself.

At block 116, via the mechanism of the print engine (50), the server system (14) retrieves the image from the server system (12). At block 118, a physical print of the image is made, and at block 120 the physical print of the image is mailed to the mailing address stipulated in the user account associated with the user of the client system (16).

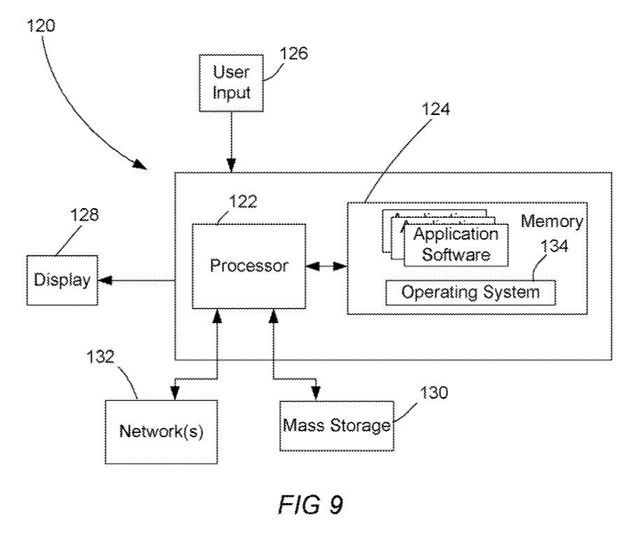

Referring to FIG. 9 of the drawings, reference numeral 120 generally indicates hardware that may be used to implement any of the systems (12), (14), or (16), in accordance with one embodiment. The hardware (120) typically includes at least one processor (122) coupled to a memory (124). The processor (122) may represent one or more processors (e.g., microprocessors), and the memory 124 may represent random access memory (RAM) devices comprising a main storage of the hardware (120), as well as any supplemental levels of memory e.g., cache memories, non-volatile or back-up memories (e.g. programmable or flash memories), read-only memories, etc. In addition, the memory (124) may be considered to include memory storage physically located elsewhere in the hardware (120), e.g. any cache memory in the processor (122), as well as any storage capacity used as a virtual memory, e.g., as stored on a mass storage device (130).

The hardware (120) also typically receives a number of inputs and outputs for communicating information externally. For interface with a user or operator, the hardware (120) may include one or more user input devices (126) (e.g., a keyboard, a mouse, etc.) and a display (128) (e.g., a Cathode Ray Tube (CRT) monitor, a Liquid Crystal Display (LCD) panel).

For additional storage, the hardware (120) may also include one or more mass storage devices (130), e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware (120) may include an interface with one or more networks (132) (e.g., a local area network (LAN), a wide area network (WAN), a wireless network, and/or the Internet among others) to permit the communication of information with other computers coupled to the networks. It should be appreciated that the hardware (120) typically includes suitable analog and/or digital interfaces between the processor (122) and each of the components (124), (126), (128) and (132) as is well known in the art.

The hardware (120) operates under the control of an operating system (134), and executes various computer software applications, components, programs, objects, modules, etc. (e.g. a program or module which performs operations described above) to perform other operations described with reference to FIGS. 1 through 7. Moreover, various applications, components, programs, objects, etc. may also execute on one or more processors in another computer coupled to the hardware (120) via a network (132), e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs,”. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

One advantage of the techniques described above is that they facilitate the printing of images from any arbitrary website. For example a user may maintain a personal website or blog and may upload images, say of his/her newborn baby, to that website with the intent to share those images with close friends and family. Using the techniques described above, once the images have been uploaded to the website, the user, in one embodiment, is prompted to indicate whether any of the images are “printable,”. If the user indicates that a particular image is printable, then a print icon or button is generated for that image when the image is rendered on a browser of a viewing client system. In accordance with a registration procedure completed with a server of an online print service, the user may indicate that the images of his/her newborn baby are to be printed at no cost to a selected group of users (friends/family). Servers associated with the user's personal website would then invite or transmit a link to the invited users, which link when activated will enable the invited users to view the images and any of the associated print buttons/icons. In accordance with the above described technique, an invited user (friend/family member) can activate the print button/icon to cause an online print service to print and deliver the image associated with the print button/icon. In the above example, the invited users are not burdened with the cost of having to print any image. However, in the use case of, say a professional photographer, when the professional photographer uploads an image to his/her personal website and indicates that that particular image is “printable”, the photographer will be given the option to specify the amount that is to be collected when the photograph is printed. In this case, when the image is printed, servers of the online print service collect the specified amount and cause same to be paid over to the professional photographer.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method to print an image from an arbitrary website, comprising:
on a server system associated with the arbitrary website:
generating a link to the image; and sending the link to a client system;
on a server system associated with an online print service:
receiving the link to the image in the form of a request from the client system;
retrieving the image from the server system associated with the arbitrary website;
making a physical print of the image; and
mailing the physical print to a mailing address.

2. The method of claim 1 further comprising, on the server system associated with the online print server, performing an authentication operation to authenticate the client system prior to receiving the image.

3. The method of claim 1, wherein generating the link to the image comprises of generating an encrypted link based on an encryption key received from the server system associated with the online print server.

4. The method of claim 1, wherein the link comprises a monetary amount due to an operator of the arbitrary website for the image.

5. The method of claim 2, wherein the authentication operation comprises retrieving a cookie from the client system.

6. The method of claim 2, wherein if the client system fails the authentication operation, then performing a registration operation to create a new account associated the client system.

7. The method of claim 1, further comprising, on the server system associated with the online print service, charging a user account associated with the client system for the printing and sending of image.

8. The method of claim 4, further comprising on the server system associated with the online print service, collecting from a user account associated with the client system, the monetary amount due to the operator.

9. The method of claim 8, further comprising paying the monetary amount over to the user account associated with the client system.

10. A method to print an image from an arbitrary website, comprising:
on a server system associated with an online print server
receiving a request to print an image, the request containing a location of the image on an independent server system associated with the arbitrary website, the request being received from a client system; and
performing an authentication operation to authenticate the client system; and
if the authentication of the client system is successful, then retrieving the image from the independent server system; printing a physical copy of the image; and mailing a physical copy of the image to a physical address associated with the client system.

11. The method of claim 10, further comprising, in the case of the client system failing the authentication operation, then performing a registration operation to create a new user account associated with the client system.

12. The method of claim 10, further comprising sending an encryption key to the independent server system to enable the independent server system to generate an encrypted link to the image based on the encryption key.

13. A method to print an image from an arbitrary website, comprising:
on a server system associated with the arbitrary website:
generating a link to the image and;
sending the link to a client system.

14. The method of claim 13, further comprising receiving an encryption key from a server system associated with an online print service, generating the link then comprising an encrypted link using the encryption key.

15. The method of claim 14, wherein the link comprises a monetary amount to be paid to an operator of the arbitrary website in respect to the image.

16. A computer readable medium, having stored thereon a sequence of instructions which when executed by a processing system, cause the system to perform a method to print an image from an arbitrary website, the method comprising:
on a server system associated with an online print server
receiving a request to print an image, the request containing a location of the image on an independent server system associated with the arbitrary website, the request being received from a client system; and
performing an authentication operation to authenticate the client system; and
if the authentication of the client system is successful, then retrieving the image from the independent server system;
printing a physical copy of the image; and mailing a physical copy of the image to a physical address associated with the client system.

17. A system to print an image from an arbitrary website, the system comprising:
a processor; and
a memory coupled to a processor, the memory storing instructions which when executed by the processor, cause the processor to
receive a request to print an image, the request containing a location of the image independent server system associated with the arbitrary website, the request being received from a client system;
perform an authentication operation to authenticate the client system; and
if the authentication of the client system is successful, the retrieving the image from the independent server system; printing a physical copy of the image; and mailing the physical copy of the image to a physical address associated with the client system.

18. A computer readable medium having stored thereon a sequence of instructions which when executed by a processor, cause the processor to perform a method to print an image from an arbitrary website, the method comprising:
generating a link to the image; and
sending the link to a client system.

19. A system to print an image from an arbitrary website, the system comprising:
a processor; and
a memory coupled to the processor; the memory storing instructions which when executed by the processor, cause the processor to
generate a link to the image; and
send the link to a client system.
